(19) United States
(12) Patent Application Publication
(10) Pub. No.: US 2025/0104185 A1
(43) Pub. Date: Mar. 27, 2025

(54) ADAPTIVE IMAGE FRAME QUANTITY DETERMINATION FOR A MULTI-FRAME IMAGE CAPTURE OPERATION

(71) Applicant: QUALCOMM Incorporated, San Diego, CA (US)

(72) Inventor: Praveen Kota, Tiruvannamalai (IN)

(21) Appl. No.: 18/475,539

(22) Filed: Sep. 27, 2023

(51) Int. Cl. G06T 3/40

(52) U.S. Cl. CPC G06T 3/4038

(57) ABSTRACT

An apparatus includes a processing system including one or more memories and one or more processors coupled to the one or more memories. The processing system is configured to determine a first quantity of frames for a multi-frame image capture operation, to initiate capture of one or more frames of the multi-frame image capture operation using a camera, and to determine a second quantity of frames for the multi-frame image capture operation after capturing the one or more frames and prior to completing the multi-frame image capture operation. The processing system is further configured to generate a composite image in accordance with the second quantity of frames.

### TECHNICAL FIELD

Aspects of the disclosure relate generally to image processing for electronic devices, and more particularly, to multi-frame image capture operations for electronic devices.

### INTRODUCTION

Image capture devices are devices that can capture one or more digital images, whether still images for photos or sequences of images for videos. Capture devices can be incorporated into a wide variety of devices. By way of example, image capture devices may comprise stand-alone digital cameras or digital video camcorders, camera-equipped wireless communication device handsets, such as mobile telephones, cellular or satellite radio telephones, personal digital assistants (PDAs), panels or tablets, gaming devices, computing devices such as webcams, video surveillance cameras, or other devices with digital imaging or video capabilities.

Some image capture devices may use multi-frame image processing to generate a snapshot image using multiple image frames. For example, an image capture device may iteratively combine or “blend” the multiple image frames to generate a snapshot image. Such a snapshot image may produce a different or improved effect as compared to other types of images, such as an image generated using a single image frame.

In some cases, the particular quantity of images used to generate a snapshot image may affect the quality of the snapshot image, such as if the particular quantity is set too low (or “aggressively”) or too high (or “conservatively”). To illustrate, if the particular quantity is set too low, image features such as image brightness may be diminished, reducing image quality. If the particular quantity is set too high, latency and power consumption may be increased. In some implementations, such increased power consumption may reduce the operating time of a battery-powered image capture device, such as a mobile phone.

### BRIEF SUMMARY OF SOME EXAMPLES

In some aspects of the disclosure, an apparatus includes a processing system including one or more memories and one or more processors coupled to the one or more memories. The processing system is configured to determine a first quantity of frames for a multi-frame image capture operation, to initiate capture of one or more frames of the multi-frame image capture operation using a camera, and to determine a second quantity of frames for the multi-frame image capture operation after capturing the one or more frames and prior to completing the multi-frame image capture operation. The processing system is further configured to generate a composite image in accordance with the second quantity of frames.

In some other aspects of the disclosure, a method includes determining a first quantity of frames for a multi-frame image capture operation, capturing one or more frames of the multi-frame image capture operation using a camera, and determining a second quantity of frames for the multi-frame image capture operation after capturing the one or more frames and prior to completing the multi-frame image capture operation. The method further includes generating a composite image in accordance with the second quantity of frames.

In some other aspects of the disclosure, a non-transitory computer-readable medium stores instructions executable by one or more processors to initiate, control, or perform operations. The operations include determining a first quantity of frames for a multi-frame image capture operation, capturing one or more frames of the multi-frame image capture operation using a camera, and determining a second quantity of frames for the multi-frame image capture operation after capturing the one or more frames and prior to completing the multi-frame image capture operation. The operations further include generating a composite image in accordance with the second quantity of frames.

Methods of image processing described herein may be performed by an image capture device and/or performed on image data captured by one or more image capture devices. Image capture devices, devices that can capture one or more digital images, whether still image photos or sequences of images for videos, can be incorporated into a wide variety of devices. By way of example, image capture devices may comprise stand-alone digital cameras or digital video camcorders, camera-equipped wireless communication device handsets, such as mobile telephones, cellular or satellite radio telephones, personal digital assistants (PDAs), panels or tablets, gaming devices, computing devices such as webcams, video surveillance cameras, or other devices with digital imaging or video capabilities.

One or more image processing techniques described herein may involve digital cameras having image sensors and processing circuitry (e.g., application specific integrated circuits (ASICs), digital signal processors (DSP), graphics processing unit (GPU), or central processing units (CPU)). An image signal processor (ISP) may include one or more of these processing circuits and configured to perform operations to obtain the image data for processing according to the image processing techniques described herein and/or involved in the image processing techniques described herein. The ISP may be configured to control the capture of image frames from one or more image sensors and determine one or more image frames from the one or more image sensors to generate a view of a scene in an output image frame. The output image frame may be part of a sequence of image frames forming a video sequence. The video sequence may include other image frames received from the image sensor or other images sensors.

In an example application, the image signal processor (ISP) may receive an instruction to capture a sequence of image frames in response to the loading of software, such as a camera application, to produce a preview display from the image capture device. The image signal processor may be configured to produce a single flow of output image frames, based on images frames received from one or more image sensors. The single flow of output image frames may include raw image data from an image sensor, binned image data from an image sensor, or corrected image data processed by one or more algorithms within the image signal processor. For example, an image frame obtained from an image sensor, which may have performed some processing on the data before output to the image signal processor, may be processed in the image signal processor by processing the image frame through an image post-processing engine (IPE) and/or other image processing circuitry for performing one or more of tone mapping, portrait lighting, contrast enhancement, gamma correction, etc. The output image frame from the ISP may be stored in memory and retrieved by an application processor executing the camera application, which may perform further processing on the output image frame to adjust an appearance of the output image frame and reproduce the output image frame on a display for view by the user.

After an output image frame representing the scene is determined by the image signal processor and/or determined by the application processor, such as through image processing techniques described in various embodiments herein, the output image frame may be displayed on a device display as a single still image and/or as part of a video sequence, saved to a storage device as a picture or a video sequence, transmitted over a network, and/or printed to an output medium. For example, the image signal processor (ISP) may be configured to obtain input frames of image data (e.g., pixel values) from the one or more image sensors, and in turn, produce corresponding output image frames (e.g., preview display frames, still-image captures, frames for video, frames for object tracking, etc.). In other examples, the image signal processor may output image frames to various output devices and/or camera modules for further processing, such as for 3A parameter synchronization (e.g., automatic focus (AF), automatic white balance (AWB), and automatic exposure control (AEC)), producing a video file via the output frames, configuring frames for display, configuring frames for storage, transmitting the frames through a network connection, etc. Generally, the image signal processor (ISP) may obtain incoming frames from one or more image sensors and produce and output a flow of output frames to various output destinations.

In some aspects, the output image frame may be produced by combining aspects of the image correction of this disclosure with other computational photography techniques such as high dynamic range (HDR) photography or multi-frame noise reduction (MFNR). With HDR photography, a first image frame and a second image frame are captured using different exposure times, different apertures, different lenses, and/or other characteristics that may result in improved dynamic range of a fused image when the two image frames are combined. In some aspects, the method may be performed for MFNR photography in which the first image frame and a second image frame are captured using the same or different exposure times and fused to generate a corrected first image frame with reduced noise compared to the captured first image frame.

In some aspects, a device may include an image signal processor or a processor (e.g., an application processor) including specific functionality for camera controls and/or processing, such as enabling or disabling the binning module or otherwise controlling aspects of the image correction. The methods and techniques described herein may be entirely performed by the image signal processor or a processor, or various operations may be split between the image signal processor and a processor, and in some aspects split across additional processors.

The device may include one, two, or more image sensors, such as a first image sensor. When multiple image sensors are present, the image sensors may be differently configured. For example, the first image sensor may have a larger field of view (FOV) than the second image sensor, or the first image sensor may have different sensitivity or different dynamic range than the second image sensor. In one example, the first image sensor may be a wide-angle image sensor, and the second image sensor may be a tele image sensor. In another example, the first sensor is configured to obtain an image through a first lens with a first optical axis and the second sensor is configured to obtain an image through a second lens with a second optical axis different from the first optical axis. Additionally or alternatively, the first lens may have a first magnification, and the second lens may have a second magnification different from the first magnification. Any of these or other configurations may be part of a lens cluster on a mobile device, such as where multiple image sensors and associated lenses are located in offset locations on a frontside or a backside of the mobile device. Additional image sensors may be included with larger, smaller, or same field of views. The image processing techniques described herein may be applied to image frames captured from any of the image sensors in a multi-sensor device.

In an additional aspect of the disclosure, a device configured for image processing and/or image capture is disclosed. The apparatus includes means for capturing image frames. The apparatus further includes one or more means for capturing data representative of a scene, such as image sensors (including charge-coupled devices (CCDs), Bayer-filter sensors, infrared (IR) detectors, ultraviolet (UV) detectors, complimentary metal-oxide-semiconductor (CMOS) sensors) and time of flight detectors. The apparatus may further include one or more means for accumulating and/or focusing light rays into the one or more image sensors (including simple lenses, compound lenses, spherical lenses, and non-spherical lenses). These components may be controlled to capture the first and/or second image frames input to the image processing techniques described herein.

Other aspects, features, and implementations will become apparent to those of ordinary skill in the art, upon reviewing the following description of specific, exemplary aspects in conjunction with the accompanying figures. While features may be discussed relative to certain aspects and figures below, various aspects may include one or more of the advantageous features discussed herein. In other words, while one or more aspects may be discussed as having certain advantageous features, one or more of such features may also be used in accordance with the various aspects. In similar fashion, while exemplary aspects may be discussed below as device, system, or method aspects, the exemplary aspects may be implemented in various devices, systems, and methods.

The method may be embedded in a computer-readable medium as computer program code comprising instructions that cause a processor to perform the steps of the method. In some embodiments, the processor may be part of a mobile device including a first network adaptor configured to transmit data, such as images or videos in a recording or as streaming data, over a first network connection of a plurality of network connections; and a processor coupled to the first network adaptor and the memory. The processor may cause the transmission of output image frames described herein over a wireless communications network such as a 5G NR communication network.

The foregoing has outlined, rather broadly, the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, aspects and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described aspects. For example, transmission and reception of wireless signals necessarily includes a number of components for analog and digital purposes (e.g., hardware components including antenna, radio frequency (RF)-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

### BRIEF DESCRIPTION OF THE DRAWINGS

A further understanding of the nature and advantages of the disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 is a diagram of an example device for adaptive image frame quantity determination in accordance with one or more aspects of the disclosure.

FIG. 2 is a diagram illustrating an example data flow path for adaptive image frame quantity determination in accordance with one or more aspects of the disclosure.

FIG. 3 is a flow chart of an example of a method for adaptive image frame quantity determination in accordance with one or more aspects of the disclosure.

FIG. 4 is a flow chart of another example of a method for adaptive image frame quantity determination in accordance with one or more aspects of the disclosure.

### DETAILED DESCRIPTION

In some aspects of the disclosure, an image capture device may adaptively select a quantity of frames for a multi-frame image capture operation. To illustrate, prior to initiating the multi-frame image capture operation, the image capture device may select a first quantity of frames. The first quantity of frames may be based on a first measurement of an ambient lighting condition associated with the image capture device.

After determining the first quantity, the image capture device may initiate the multi-frame image capture operation, such as by capturing one or more frames (e.g., by capturing some, but not all, of the first quantity of frames). After initiating the multi-frame image capture operation, and prior to completing the multi-frame image capture operation, the image capture device may perform one or more second measurements of the ambient lighting condition (e.g., to reevaluate the first quantity based on one or more current lighting conditions associated with the image capture device). In some examples, the image capture device may determine a second quantity of frames based on the one or more second measurements of the ambient lighting condition. The image capture device may complete the multi-frame image capture operation based on the second quantity and may generate a composite image (also referred to herein as a batch image or snapshot image) based on the second quantity of frames.

By reevaluating a quantity of frames of a multi-frame image capture operation after initiating the multi-frame image capture operation, performance of an image capture device may be improved. For example, if an amount of ambient lighting is reduced after initiating the multi-frame image capture operation (such as if a user turns off a light or enters a dark environment), the image capture device may dynamically increase the quantity of frames based on current lighting conditions. In such examples, quality of the composite image may be enhanced as compared to use of a lower quantity of frames, which may result in a poor brightness level of the composite image. In some other examples, if an amount of ambient lighting is increased after initiating the multi-frame image capture operation (such as if a user turns on a light or leaves a dark environment), the image capture device may dynamically decrease the quantity of frames based on current lighting conditions. In such examples, reevaluating the quantity of frames may reduce latency or power consumption by reducing the number of images used to generate the composite image.

In the description of embodiments herein, some specific details are set forth, such as examples of specific components, circuits, and processes to provide a thorough understanding of the disclosure. The term “coupled” as used herein means connected directly to or connected through one or more intervening components or circuits. Also, in the following description and for purposes of explanation, specific nomenclature is set forth to provide a thorough understanding of the disclosure. However, it will be apparent to one skilled in the art that these specific details may not be required to practice the teachings disclosed herein. In other instances, some circuits and devices are shown in block diagram form for illustration.

Some portions of the detailed descriptions which follow are presented in terms of procedures, logic blocks, processing, and other symbolic representations of operations on data bits within a computer memory. In the disclosure, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

An example device for capturing image frames using one or more image sensors, such as a smartphone, may include a configuration of one, two, three, four, or more camera modules on a backside (e.g., a side opposite a primary user display) and/or a front side (e.g., a same side as a primary user display) of the device. The devices may include one or more image signal processors (ISPs), Computer Vision Processors (CVPs) (e.g., AI engines), or other suitable circuitry for processing images captured by the image sensors. The one or more image signal processors (ISP) may store output image frames (such as through a bus) in a memory and/or provide the output image frames to processing circuitry (such as an applications processor). The processing circuitry may perform further processing, such as for encoding, storage, transmission, or other manipulation of the output image frames.

As used herein, a camera module may include the image sensor and certain other components coupled to the image sensor used to obtain a representation of a scene in image data comprising an image frame. For example, a camera module may include other components of a camera, including a shutter, buffer, or other readout circuitry for accessing individual pixels of an image sensor. In some embodiments, the camera module may include one or more components including the image sensor included in a single package with an interface configured to couple the camera module to an image signal processor or other processor through a bus.

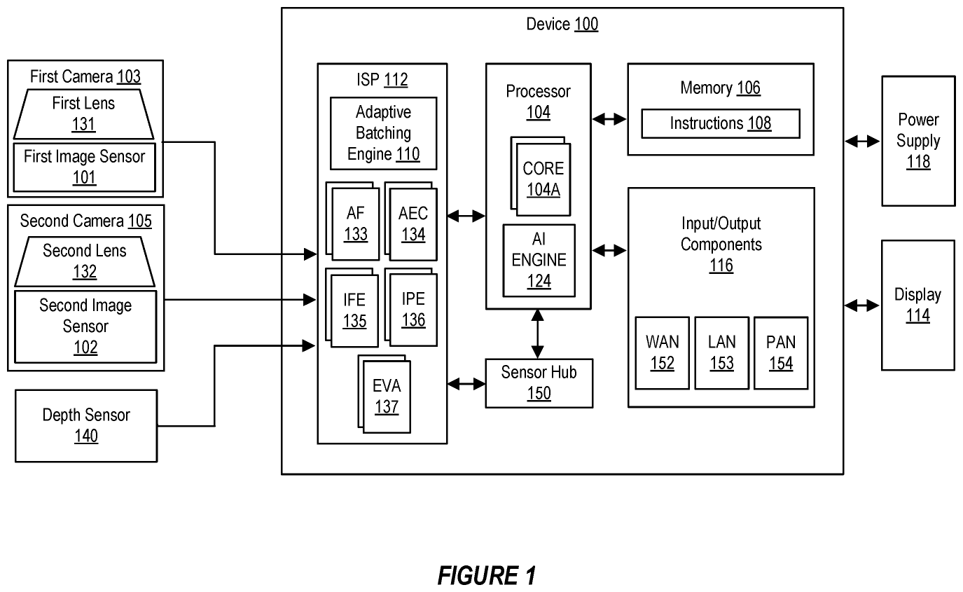

FIG. 1 is a block diagram of a device 100 for adaptive image frame quantity determination in accordance with one or more aspects of the disclosure. The device 100 may include, or otherwise be coupled to, an image signal processor (e.g., ISP 112) for processing image frames from one or more image sensors, such as a first image sensor 101, a second image sensor 102, and a depth sensor 140. In some implementations, the device 100 also includes or is coupled to a processor 104 and a memory 106 storing instructions 108 (e.g., a memory storing processor-readable code or a non-transitory computer-readable medium storing instructions). The device 100 may also include or be coupled to a display 114 and components 116. Components 116 may be used for interacting with a user, such as a touch screen interface and/or physical buttons.

Components 116 may also include network interfaces for communicating with other devices, including a wide area network (WAN) adaptor (e.g., WAN adaptor 152), a local area network (LAN) adaptor (e.g., LAN adaptor 153), and/or a personal area network (PAN) adaptor (e.g., PAN adaptor 154). A WAN adaptor 152 may be a 4G LTE or a 5G NR wireless network adaptor. A LAN adaptor 153 may be an IEEE 802.11 WiFi wireless network adapter. A PAN adaptor 154 may be a Bluetooth wireless network adaptor. Each of the WAN adaptor 152, LAN adaptor 153, and/or PAN adaptor 154 may be coupled to an antenna, including multiple antennas configured for primary and diversity reception and/or configured for receiving specific frequency bands. In some embodiments, antennas may be shared for communicating on different networks by the WAN adaptor 152, LAN adaptor 153, and/or PAN adaptor 154. In some embodiments, the WAN adaptor 152, LAN adaptor 153, and/or PAN adaptor 154 may share circuitry and/or be packaged together, such as when the LAN adaptor 153 and the PAN adaptor 154 are packaged as a single integrated circuit (IC).

The device 100 may further include or be coupled to a power supply 118 for the device 100, such as a battery or an adaptor to couple the device 100 to an energy source. The device 100 may also include or be coupled to additional features or components that are not shown in FIG. 1. In one example, a wireless interface, which may include a number of transceivers and a baseband processor in a radio frequency front end (RFFE), may be coupled to or included in WAN adaptor 152 for a wireless communication device. In a further example, an analog front end (AFE) to convert analog image data to digital image data may be coupled between the first image sensor 101 or second image sensor 102 and processing circuitry in the device 100. In some embodiments, AFEs may be embedded in the ISP 112.

The device may include or be coupled to a sensor hub 150 for interfacing with sensors to receive data regarding movement of the device 100, data regarding an environment around the device 100, and/or other non-camera sensor data. One example non-camera sensor is a gyroscope, which is a device configured for measuring rotation, orientation, and/or angular velocity to generate motion data. Another example non-camera sensor is an accelerometer, which is a device configured for measuring acceleration, which may also be used to determine velocity and distance traveled by appropriately integrating the measured acceleration. In some aspects, a gyroscope in an electronic image stabilization system (EIS) may be coupled to the sensor hub. In another example, a non-camera sensor may be a global positioning system (GPS) receiver, which is a device for processing satellite signals, such as through triangulation and other techniques, to determine a location of the device 100. The location may be tracked over time to determine additional motion information, such as velocity and acceleration. The data from one or more sensors may be accumulated as motion data by the sensor hub 150. One or more of the acceleration, velocity, and/or distance may be included in motion data provided by the sensor hub 150 to other components of the device 100, including the ISP 112 and/or the processor 104.

The ISP 112 may receive captured image data. In one embodiment, a local bus connection couples the ISP 112 to the first image sensor 101 and second image sensor 102 of a first camera 103 and second camera 105, respectively. In another embodiment, a wire interface couples the ISP 112 to an external image sensor. In a further embodiment, a wireless interface couples the ISP 112 to the first image sensor 101 or second image sensor 102.

The first image sensor 101 and the second image sensor 102 are configured to capture image data representing a scene in the field of view of the first camera 103 and second camera 105, respectively. In some embodiments, the first camera 103 and/or second camera 105 output analog data, which is converted by an analog front end (AFE) and/or an analog-to-digital converter (ADC) in the device 100 or embedded in the ISP 112. In some embodiments, the first camera 103 and/or second camera 105 output digital data. The digital image data may be formatted as one or more image frames, whether received from the first camera 103 and/or second camera 105 or converted from analog data received from the first camera 103 and/or second camera 105.

The first camera 103 may include the first image sensor 101 and a first lens 131. The second camera may include the second image sensor 102 and a second lens 132. Each of the first lens 131 and the second lens 132 may be controlled by an associated an autofocus (AF) algorithm (e.g., AF 133) executing in the ISP 112, which adjusts the first lens 131 and the second lens 132 to focus on a particular focal plane located at a certain scene depth. The AF 133 may be assisted by depth data received from depth sensor 140. The first lens 131 and the second lens 132 focus light at the first image sensor 101 and second image sensor 102, respectively, through one or more apertures for receiving light, one or more shutters for blocking light when outside an exposure window, and/or one or more color filter arrays (CFAs) for filtering light outside of specific frequency ranges. The first lens 131 and second lens 132 may have different field of views to capture different representations of a scene. For example, the first lens 131 may be an ultra-wide (UW) lens and the second lens 132 may be a wide (W) lens. The multiple image sensors may include a combination of ultra-wide (high field-of-view (FOV)), wide, tele, and ultra-tele (low FOV) sensors.

Each of the first camera 103 and second camera 105 may be configured through hardware configuration and/or software settings to obtain different, but overlapping, field of views. In some configurations, the cameras are configured with different lenses with different magnification ratios that result in different fields of view for capturing different representations of the scene. The cameras may be configured such that a UW camera has a larger FOV than a W camera, which has a larger FOV than a T camera, which has a larger FOV than a UT camera. For example, a camera configured for wide FOV may capture fields of view in the range of 64-84 degrees, a camera configured for ultra-side FOV may capture fields of view in the range of 100-140 degrees, a camera configured for tele FOV may capture fields of view in the range of 10-30 degrees, and a camera configured for ultra-tele FOV may capture fields of view in the range of 1-8 degrees.

In some embodiments, one or more of the first camera 103 and/or second camera 105 may be a variable aperture (VA) camera in which the aperture can be adjusted to set a particular aperture size. Example aperture sizes include f/2.0, f/2.8, f/3.2, f/8.0, etc. Larger aperture values correspond to smaller aperture sizes, and smaller aperture values correspond to larger aperture sizes. A variable aperture (VA) camera may have different characteristics that produced different representations of a scene based on a current aperture size. For example, a VA camera may capture image data with a depth of focus (DOF) corresponding to a current aperture size set for the VA camera.

The ISP 112 processes image frames captured by the first camera 103 and second camera 105. While FIG. 1 illustrates the device 100 as including first camera 103 and second camera 105, any number (e.g., one, two, three, four, five, six, etc.) of cameras may be coupled to the ISP 112. In some aspects, depth sensors such as depth sensor 140 may be coupled to the ISP 112. Output from the depth sensor 140 may be processed in a similar manner to that of first camera 103 and second camera 105. Examples of depth sensor 140 include active sensors, including one or more of indirect Time of Flight (iToF), direct Time of Flight (dToF), light detection and ranging (Lidar), mm Wave, radio detection and ranging (Radar), and/or hybrid depth sensors, such as structured light sensors. In embodiments without a depth sensor 140, similar information regarding depth of objects or a depth map may be determined from the disparity between first camera 103 and second camera 105, such as by using a depth-from-disparity algorithm, a depth-from-stereo algorithm, phase detection auto-focus (PDAF) sensors, or the like. In addition, any number of additional image sensors or image signal processors may exist for the device 100.

In some embodiments, the ISP 112 may execute instructions from a memory, such as instructions 108 from the memory 106, instructions stored in a separate memory coupled to or included in the ISP 112, or instructions provided by the processor 104. In addition, or in the alternative, the ISP 112 may include specific hardware (such as one or more integrated circuits (ICs)) configured to perform one or more operations described in the disclosure. For example, the ISP 112 may include image front ends (e.g., IFE 135), image post-processing engines (e.g., IPE 136), auto exposure compensation (AEC) engines (e.g., AEC 134), and/or one or more engines for video analytics (e.g., EVA 137). An image pipeline may be formed by a sequence of one or more of the IFE 135, IPE 136, and/or EVA 137. In some embodiments, the image pipeline may be reconfigurable in the ISP 112 by changing connections between the IFE 135, IPE 136, and/or EVA 137. The AF 133, AEC 134, IFE 135, IPE 136, and EVA 137 may each include application-specific circuitry, be embodied as software or firmware executed by the ISP 112, and/or a combination of hardware and software or firmware executing on the ISP 112.

The memory 106 may include a non-transient or non-transitory computer readable medium storing computer-executable instructions as instructions 108 to perform all or a portion of one or more operations described in this disclosure. The instructions 108 may include a camera application (or other suitable application such as a messaging application) to be executed by the device 100 for photography or videography. The instructions 108 may also include other applications or programs executed by the device 100, such as an operating system and applications other than for image or video generation. Execution of the camera application, such as by the processor 104, may cause the device 100 to record images using the first camera 103 and/or second camera 105 and the ISP 112.

In addition to instructions 108, the memory 106 may also store image frames. The image frames may be output image frames stored by the ISP 112. The output image frames may be accessed by the processor 104 for further operations. In some embodiments, the device 100 does not include the memory 106. For example, the device 100 may be a circuit including the ISP 112, and the memory may be outside the device 100. The device 100 may be coupled to an external memory and configured to access the memory for writing output image frames for display or long-term storage. In some embodiments, the device 100 is a system-on-chip (SoC) that incorporates the ISP 112, the processor 104, the sensor hub 150, the memory 106, and/or components 116 into a single package.

In some examples, one or more of the ISP 112 or the processor 104 may execute instructions to perform one or more operations described herein. For example, execution of the instructions can instruct the ISP 112 to begin or end capturing an image frame or a sequence of image frames, in which the capture includes correction as described in embodiments herein. In some embodiments, the processor 104 may include one or more general-purpose processor cores 104A-N capable of executing instructions to control operation of the ISP 112. For example, the cores 104A-N may execute a camera application (or other suitable application for generating images or video) stored in the memory 106 that activate or deactivate the ISP 112 for capturing image frames and/or control the ISP 112 in connection with capturing the image frames. The operations of the cores 104A-N and ISP 112 may be based on user input. For example, a camera application executing on processor 104 may receive a user command to begin a video preview display upon which a video comprising a sequence of image frames is captured and processed from first camera 103 and/or the second camera 105 through the ISP 112 for display and/or storage. Image processing to determine “output” or “corrected” image frames may be applied to one or more image frames in the sequence.

In some embodiments, the processor 104 may include ICs or other hardware (e.g., an artificial intelligence (AI) engine such as AI engine 124 or other co-processor) to offload certain tasks from the cores 104A-N. The AI engine 124 may be used to offload tasks related to, for example, face detection and/or object recognition performed using machine learning (ML) or artificial intelligence (AI). The AI engine 124 may be referred to as an Artificial Intelligence Processing Unit (AI PU). The AI engine 124 may include hardware configured to perform and accelerate convolution operations involved in executing machine learning algorithms, such as by executing predictive models such as artificial neural networks (ANNs) (including multilayer feedforward neural networks (MLFFNN), the recurrent neural networks (RNN), and/or the radial basis functions (RBF)). The ANN executed by the AI engine 124 may access predefined training weights for performing operations on user data. The ANN may alternatively be trained during operation of the image capture device 100, such as through reinforcement training, supervised training, and/or unsupervised training. In some other embodiments, the device 100 does not include the processor 104, such as when all of the described functionality is configured in the ISP 112.

In some embodiments, the display 114 may include one or more suitable displays or screens allowing for user interaction and/or to present items to the user, such as a preview of the output of the first camera 103 and/or second camera 105. In some embodiments, the display 114 is a touch-sensitive display. The input/output (I/O) components, such as components 116, may be or include any suitable mechanism, interface, or device to receive input (such as commands) from the user and to provide output to the user through the display 114. For example, the components 116 may include (but are not limited to) a graphical user interface (GUI), a keyboard, a mouse, a microphone, speakers, a squeezable bezel, one or more buttons (such as a power button), a slider, a toggle, or a switch.

While shown to be coupled to each other via the processor 104, components (such as the processor 104, the memory 106, the ISP 112, the display 114, and the components 116) may be coupled to each another in other various arrangements, such as via one or more local buses, which are not shown for simplicity. One example of a bus for interconnecting the components is a peripheral component interface (PCI) express (PCIe) bus.

While the ISP 112 is illustrated as separate from the processor 104, the ISP 112 may be a core of a processor 104 that is an application processor unit (APU), included in a system on chip (SoC), or otherwise included with the processor 104. One or more device components may be omitted from FIG. 1 for convenience. Additionally, other components, numbers of components, or combinations of components may be included in a suitable device for performing aspects of the disclosure. As such, the disclosure is not limited to a specific device or configuration of components, including the device 100.

In some aspects of the disclosure, the device 100 may use one or more cameras (such as one or both of the first camera 103 or the second camera 105) to generate one or more composite images (also referred to herein as batch images or snapshot images). To generate a batch image, the device 100 may use the one or more cameras to capture multiple images. The device 100 may perform processing based on the multiple images to create the composite image, such as by combining different features of the multiple images into a composite image. The quantity (or cardinality) of the multiple images may be referred to as a batch size of the composite image.

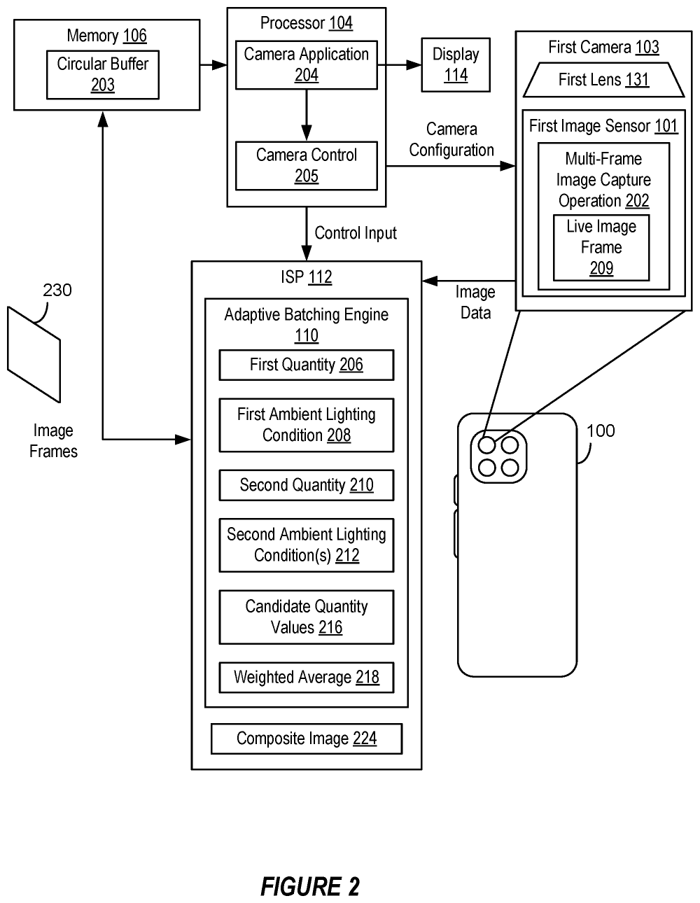

In some examples, at least one of the ISP 112 or the processor 104 executes instructions to perform adaptive determination of a batch size associated with a composite image. For example, the ISP 112 may include or may execute an adaptive batching engine 110. The adaptive batching engine 110 may enable the device 100 to adaptively modify batch sizes of composite images, such as based on ambient conditions associated with the device 100, as described further with reference to FIG. 2.

FIG. 2 is a diagram illustrating an example data flow path for adaptive image frame quantity determination in accordance with one or more aspects of the disclosure. In some examples, the image capture device may correspond to the device 100 of FIG. 1. Further, although the example of FIG. 2 may illustrate the device 100 as a smartphone device, other implementations are also within the scope of the disclosure. For example, in some implementations, the device 100 may correspond to a standalone camera or another type of device. In addition, although FIG. 2 may illustrate the first camera 103 as being a rear-facing camera of the device 100, in other implementations, the first camera 103 may be a front-facing camera or another camera of the device 100.

Processor 104 may communicate with ISP 112 through a bi-directional bus and/or separate control and data lines. The processor 104 may control the first camera 103 through camera control 205. The camera control 205 may be a camera driver executed by the processor 104 for configuring the first camera 103, such as to active or deactivate image capture, configure exposure settings, and/or configure aperture size. Camera control 205 may be managed by a camera application 204 executing on the processor 104. The camera application 204 provides settings accessible to a user such that a user can specify individual camera settings or select a profile with corresponding camera settings. Camera control 205 communicates with the first camera 103 to configure the first camera 103 in accordance with commands received from the camera application 204. The camera application 204 may be, for example, a photography application, a document scanning application, a messaging application, or other application that processes image data acquired from the first camera 103.

The camera configuration may include parameters that specify, for example, a frame rate, an image resolution, a readout duration, an exposure level, an aspect ratio, an aperture size, etc. The first camera 103 may apply the camera configuration and obtain image data representing a scene using the camera configuration. In some embodiments, the camera configuration may be adjusted to obtain different representations of the scene. For example, the processor 104 may execute a camera application 204 to instruct the first camera 103, through camera control 205, to set a first camera configuration for the first camera 103, to obtain first image data from the first camera 103 operating in the first camera configuration, to instruct the first camera 103 to set a second camera configuration for the first camera 103, and to obtain second image data from the first camera 103 operating in the second camera configuration.

In some embodiments in which the first camera 103 is a variable aperture (VA) camera system, the processor 104 may execute a camera application 204 to instruct the first camera 103 to configure to a first aperture size, obtain first image data from the first camera 103, instruct the first camera 103 to configure to a second aperture size, and obtain second image data from the first camera 103. The reconfiguration of the aperture and obtaining of the first and second image data may occur with little or no change in the scene captured at the first aperture size and the second aperture size. Example aperture sizes are f/2.0, f/2.8, f/3.2, f/8.0, etc. Larger aperture values correspond to smaller aperture sizes, and smaller aperture values correspond to larger aperture sizes. That is, f/2.0 corresponds to a larger aperture size than f/8.0.

The image data received from the first camera 103 may be processed in one or more blocks of the ISP 112 to determine output image frames 230 that may be stored in memory 106 and/or otherwise provided to the processor 104. The processor 104 may further process the image data to apply effects to the output image frames 230. Effects may include Bokeh, lighting, color casting, and/or high dynamic range (HDR) merging. In some embodiments, the effects may be applied in the ISP 112.

The output image frames 230 by the ISP 112 may include representations of a scene. The processor 104 may display these output image frames 230 to a user.

In some aspects of the disclosure, the device 100 may execute the adaptive batching engine 110 to dynamically select a batch size of a composite image 224 that is generated using a multi-frame image capture operation 202. As an illustrative example, performing the multi-frame image capture operation 202 may include capturing the image frames 230, capturing other image frames different than the image frames 230, or both. In some examples, the multi-frame image capture operation 202 may correspond to a multi-frame noise removal (MFNR) image capture operation that captures multiple images and that removes or reduces noise from one or more of the images to generate the composite image 224. Alternatively, or in addition, the multi-frame image capture operation 202 may include or correspond to one or more other image processing operations, such as a low-light image processing operation, which may include capturing multiple frames at different exposures and then combining the multiple frames to produce a final snapshot image, such as the composite image 224.

The device 100 may determine a first quantity 206 of frames of the multi-frame image capture operation 202. The device 100 may determine the first quantity 206 prior to initiating the multi-frame image capture operation 202. As an illustrative example, in some implementations, the device 100 may determine the first quantity 206 prior to providing camera configuration information to the first camera 103 to initiate the multi-frame image capture operation 202.

In some examples, the device 100 may determine the first quantity 206 in accordance with a first measurement of one or more parameters, such as one or more of a first autoexposure (AE) parameter, a first auto white balance (AWB) parameter, a first autofocus (AF) parameter, a first AE, AWB, and AF (3A) parameter, or a first sensitivity parameter. The first measurement may indicate a first ambient lighting condition associated with the device 100. To further illustrate, in some examples, the device 100 may determine the first AF parameter using the AF 133 of FIG. 1 and may determine the first AE using the AEC 134 of FIG. 1.

The device 100 may use the first measurement to determine the first quantity 206. For example, if the first measurement indicates a relatively high level of ambient lighting associated with the device 100, the adaptive batching engine 110 may set the first quantity 206 to be relatively low. In such examples, the relatively high level of ambient lighting may enable the device 100 to generate the composite image 224 using a relatively small number of image frames. In some other examples, the first measurement may indicate a relatively low level of ambient lighting associated with the device 100. In such examples, the adaptive batching engine 110 may set the first quantity 206 to be relatively high. In such examples, the device 100 may increase the number of image frames used to generate the composite image 224 to compensate for the relatively low level of ambient lighting.

The device 100 may initiate the multi-frame image capture operation 202 (e.g., after determining the first quantity 206). For example, the processor 104 or the ISP 112 may provide an instruction to the first camera 103 to cause the first camera 103 to capture at least one image frame of the multi-frame image capture operation 202.

After capturing the one or more frames and prior to completing the multi-frame image capture operation 202, the device 100 may determine a second quantity 210 of frames for the multi-frame image capture operation 202. In some examples, the device 100 may dynamically change the multi-frame image capture operation 202 from the first quantity 206 to the second quantity 210, such as based on a change in ambient lighting condition associated with the device 100.

To illustrate, the device 100 may perform one or more second measurements to determine one or more second ambient lighting conditions 212. In some examples, the device 100 may perform the one or more second measurements after initiating the multi-frame image capture operation 202 and concurrently with capturing one or more image frames of the multi-frame image capture operation 202. The device 100 may determine the one or more second ambient lighting conditions 212 in accordance with one or more of a second AE parameter different than the first AE parameter, a second AWB parameter different than the first AWB parameter, a second AF parameter different than the first AF parameter, a second 3A parameter different than the first 3A parameter, or a second sensitivity parameter different than the first sensitivity parameter. To further illustrate, in some examples, the device 100 may determine the second AF parameter using the AF 133 of FIG. 1 and may determine the second AE using the AEC 134 of FIG. 1.

In some implementations, the device 100 may determine the second quantity 210 based on multiple measurements, such as based on an average of the multiple measurements. Examples of averages includes weighted averages, non-weighted averages, and other types of averages. To illustrate, in some examples of a weighted average, the one or more second ambient lighting conditions may include or correspond to multiple measurements, and the device 100 may weight a more recent measurement of the multiple measurements more than a less recent measurement of the multiple measurements. Further, examples of weighted averages include simple averages as well as weighting a value to zero or to another value. As an illustrative example, a most recent value may be weighted to one, and other values may be weighted to zero. Some examples may assign decreasing weights as images are captured. For example, an initially captured image may be weighted more than a subsequently captured image, which may result in the composite image 224 being influenced more by lighting conditions at the time of initiation of the multi-frame image capture operation 202 than by later lighting conditions. Other examples are also within the scope of the disclosure, such as examples using increasing weights or equal weights.

In some examples, the one or more second ambient lighting conditions 212 may be associated candidate quantity values 216. In some examples, the device 100 may determine the second quantity 210 as (or based on) a weighted average 218 of the first quantity 206 and the plurality of candidate quantity values 216.

The device 100 may complete the multi-frame image capture operation 202 in accordance with the second quantity 210, such as by adjusting the multi-frame image capture operation 202 from the first quantity 206 to the second quantity 210. To illustrate, if the second quantity 210 is greater than (or less than) the first quantity 206, then the device 100 may increase (or decrease) the multi-frame image capture operation 202 from the first quantity 206 to the second quantity 210. In some other examples, if the first quantity 206 corresponds to the second quantity 210, then the device 100 may refrain from modifying the quantity of image frames associated with the multi-frame image capture operation 202.

The device 100 may generate the composite image 224 in accordance with the second quantity 210. In some implementations, generating the composite image 224 includes performing image blending operations to blend multiple image frames into the composite image 224. To illustrate, the device 100 may select a particular image frame of the multiple image frames as an anchor frame (also referred to as a reference frame). In some examples, the device 100 may select one of the multiple image frames as the anchor frame in accordance with one or more criteria, such as a sharpness criterion, a face detection (FD) criterion, or both. To illustrate, the device 100 may identify, from among the multiple image frames, a particular image frame having a greatest sharpness metric, a greatest correlation to a face profile, or both. In such examples, the device 100 may select the particular image frame as the anchor frame. In some implementations, performing the image blending operations may include performing noise reduction (e.g., MFNR) to generate the composite image 224.

Further, generating the composite image 224 may include adjusting a quantity of the image blending operations from the first quantity 206 to the second quantity 210. In addition, the candidate quantity values 216 may be respectively associated with at least a subset of the image blending operations.

Certain examples may be described herein with reference to “live” image frames. For example, in some implementations, the adaptive batching engine 110 may dynamically select a quantity of images for the multi-frame image capture operation 202 as images are captured. Other examples are also within the scope of the disclosure. For example, in some other implementations, the adaptive batching engine 110 may use previously stored image frames alternatively or in addition to using such “live” image frames.

To illustrate, the device 100 may generate the image frames 230 and may store the image frames 230 to a buffer, cache, or memory, such as the memory 106. In some examples, the image frames 230 may include or correspond to raw images or raw image data. As an illustrative example, the device 100 may capture the image frames 230 using a zero shutter lag (ZSL) mode of operation in which the device 100 continuously captures the image frames 230 and stores the image frames 230 to a storage region, such as a circular buffer 203, which may be included in the memory 106. The image frames 230 may include the first quantity 206 of image frames, and the circular buffer 203 may have a buffer size corresponding to the first quantity 206 of image frames. After generating the first quantity of the image frames 230, the ISP 112 may retrieve the image frames 230 (e.g., from the memory 106) and may process the image frames 230, such as by blending the image frames 230 to generate the composite image 224. In some such examples, the ISP 112 may dynamically change from the first quantity 206 to the second quantity 210 during processing of the image frames 230, such as by discarding one or more image frames of the image frames 230, or by capturing one or more “live” image frames in addition to the image frames 230.

In a particular example, the device 100 may display one or more captured image frames to a user via the display 114, such as in connection with an image preview. Further, image frames may be continuously captured and stored to the circular buffer 203. To illustrate, during a ZSL mode of operation of the device 100, captured image frames (e.g., the image frames 230) may be continuously stored to a volatile memory (such as the circular buffer 203) in addition to sending such image frames to the display 114 for the image preview. At least some (or all) such stored image frames may be retrieved and used to generate the composite image 224 (e.g., a snapshot image). Alternatively or in addition to using such stored image frames, in some cases, one or more “live” image frames (such as an illustrative live image frame 209) may be used to generate the composite image 224 prior to (or without) storing such “live” image frames to the volatile memory (e.g., the circular buffer 203). After generating the composite image 224, the composite image 224 may be provided to (or may be made accessible to) an application executed by the device 100 that may store or “commit” the composite image 224 to a memory (e.g., a non-volatile memory of the device 100).

Accordingly, in some examples, the device 100 may retrieve at least one previously stored image frame (such as any of the image frames 230) from the circular buffer 203. The at least one previously stored image frame may be associated with a ZSL mode of operation of the device 100. The device 100 may generate the composite image 224 based at least in part on the at least one previously stored image frame. In some examples, the device 100 may generate the composite image 224 based on both the at least one previously stored image frame and another image frame, such as the live image frame 209 (prior to or without the live image frame 209 being stored to the circular buffer 203).

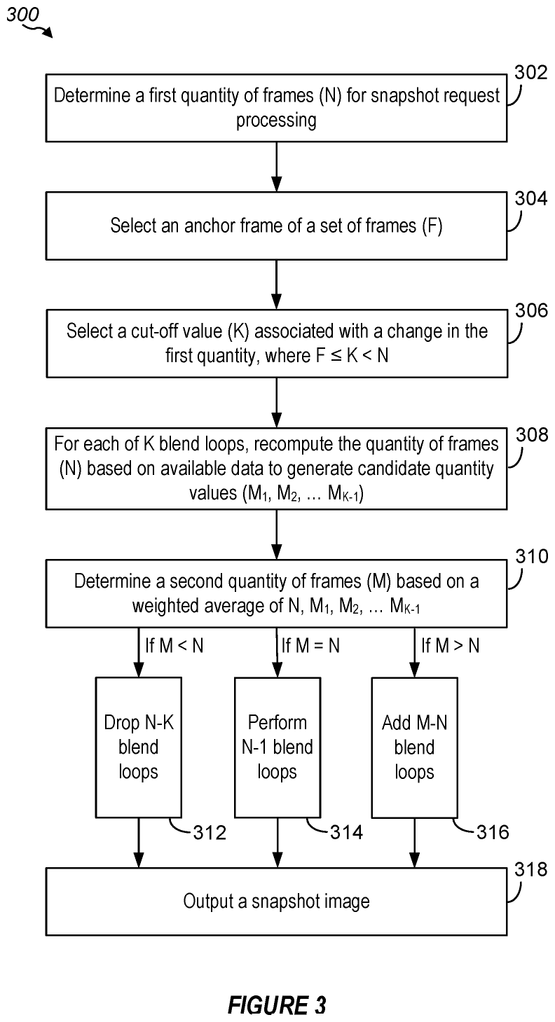

FIG. 3 is a flow chart illustrating an example of a method 300 for adaptive image frame quantity determination in accordance with one or more aspects of the disclosure. In some examples, the method 300 may be performed by the device 100. For example, one or more operations of the method 300 may be performed, initiated, or controlled by one or both of the processor 104 or the ISP 112, such as by executing the adaptive batching engine 110.

At 302, the method 300 may include determining a first quantity of frames (N) for snapshot request processing. The first quantity of frames (N) may correspond to the first quantity 206 of FIG. 2. In some examples, the device 100 may determine the first quantity of frames (N) based on 3A data, which may correspond to or may be associated with the first ambient lighting condition 208.

At 304, the method 300 may further include selecting an anchor frame of a set of frames (F). To illustrate, the set of frames (F) may be included in image data provided from the first camera 103 or the second camera 105 to the ISP 112.

At 306, the method 300 may further include selecting a cut-off value (K, where F≤K<N) associated with a change in the first quantity. For example, K may correspond to a minimum quantity of frames after which the first quantity may be updated or adjusted based on current ambient lighting conditions.

At 308, the method 300 may further include, for each of K blend loops, recomputing the quantity of frames (N) based on available data to generate candidate quantity values (M₁, M₂, . . . M_{K-1}). For example, the device 100 each of the candidate quantity values 216 may correspond to a recomputed version of the first quantity 206 that is recomputed at a respective blend loop of the K blend loops based on a current ambient lighting condition. Such current ambient lighting conditions may be included in the one or more second ambient lighting conditions 212. Further, in an example, the one or more second ambient lighting conditions 212 may include K ambient lighting conditions, and the candidate quantity values 216 may include K candidate quantity values.

At 310, the method 300 may further include determining a second quantity of frames (M) based on a weighted average of N, M₁, M₂, . . . M_{K-1}. For example, the device 100 may determine the second quantity 210 based on the weighted average 218 the first quantity 206 and the candidate quantity values 216.

In some examples, if M<N, the method 300 may further include dropping N−K blend loops, at 312. In such examples, the device 100 may subtract N−K blend loops from N to determine M<N blend loops. The device may generate the composite image 224 using the M<N blend loops.

In some other examples, if M=N, the method 300 may further include performing N−1 blend loops, at 314. In such examples, the device 100 may generate the composite image 224 using the M=N blend loops.

In some further examples, if M>N, the method 300 may further include adding M−N blend loops, at 316. In such examples, the device 100 may add M−N blend loops to N to determine M>N blend loops. The device may generate the composite image 224 using the M>N blend loops.

At 318, the method 300 may further include outputting a snapshot image. As an illustrative example, the ISP 112 may output the composite image 224, such as to the memory 106, to the processor 104, to one or more other devices or components, or a combination thereof.

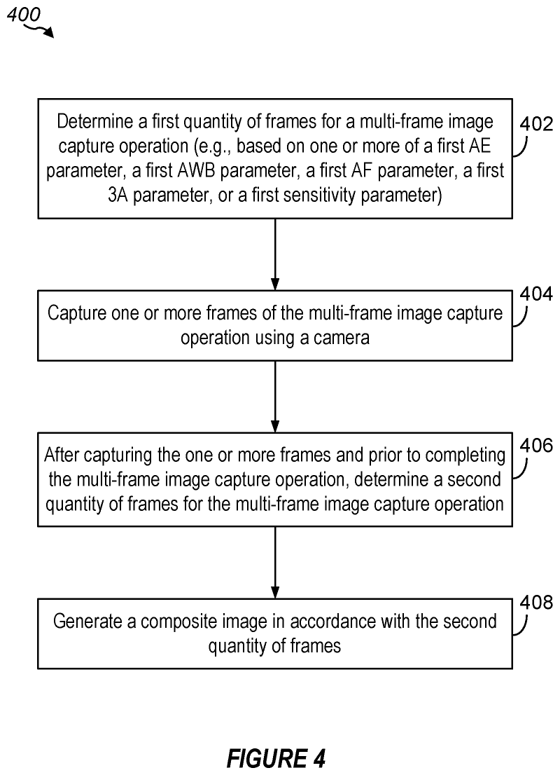

FIG. 4 is a flow chart illustrating another example of a method 400 for adaptive image frame quantity determination in accordance with one or more aspects of the disclosure. In some examples, the method 400 may be performed by the device 100. For example, one or more operations of the method 400 may be performed, initiated, or controlled by one or both of the processor 104 or the ISP 112, such as by executing the adaptive batching engine 110.

At 402, the method 400 includes determining a first quantity of frames for a multi-frame image capture operation (e.g., based on one or more of a first AE parameter, a first AWB parameter, a first AF parameter, a first 3A parameter, or a first sensitivity parameter). For example, the device 100 may determine the first quantity 206 for the multi-frame image capture operation 202, such as based on the first ambient lighting condition 208.

At 404, the method 400 includes capturing one or more frames of the multi-frame image capture operation using a camera. For example, the device 100 may capture the image data of FIG. 2 using the first camera 103, the second camera 105, or both.

At 406, the method 400 includes determining a second quantity of frames for the multi-frame image capture operation after capturing the one or more frames and prior to completing the multi-frame image capture operation. For example, the device 100 may determine the second quantity 210 for the multi-frame image capture operation 202, such as based on the one or more second ambient lighting conditions 212.

At 408, the method 400 includes generating a composite image in accordance with the second quantity of frames. For example, the device 100 may generate the composite image 224 in accordance with the second quantity 210.

In some examples, one or more operations described herein, such as any of the operations described with reference to the methods 300 and 400, may be initiated, performed, or controlled by a processing system. The processing system includes one or more memories, such as the memory 106, the circular buffer 203, another memory, or a combination thereof. The processing system further includes one or more processors coupled to the one or more memories. For example, the one or more processors may include the processor 104, the ISP 112, another processor, or a combination thereof.

One or more aspects described herein may improve operation of an image capture device, such as the device 100. For example, by reevaluating the first quantity 206 of the multi-frame image capture operation 202 after initiating the multi-frame image capture operation 202, performance of the device 100 may be improved. To illustrate, if an amount of ambient lighting is reduced after initiating the multi-frame image capture operation 202 (such as if a user of the device 100 turns off a light or enters a dark environment), the device 100 may dynamically increase the multi-frame image capture operation 202 from the first quantity 206 to the second quantity 210 based on current lighting conditions. In such examples, quality of the composite image 224 may be enhanced as compared to use of the first quantity 206, which may result in a poor brightness level of the composite image 224. In some other examples, if an amount of ambient lighting is increased after initiating the multi-frame image capture operation 202 (such as if the user turns on a light or leaves a dark environment), the device 100 may dynamically decrease the multi-frame image capture operation 202 from the first quantity 206 to the second quantity 210 based on current lighting conditions. In such examples, decreasing the multi-frame image capture operation 202 from the first quantity 206 to the second quantity 210 may reduce latency or power consumption by reducing the number of images used to generate the composite image 224.

According to some further aspects, in a first aspect, an apparatus includes a processing system including one or more memories and one or more processors coupled to the one or more memories. The processing system is configured to determine a first quantity of frames for a multi-frame image capture operation, to initiate capture of one or more frames of the multi-frame image capture operation using a camera, and to determine a second quantity of frames for the multi-frame image capture operation after capturing the one or more frames and prior to completing the multi-frame image capture operation. The processing system is further configured to generate a composite image in accordance with the second quantity of frames.

In a second aspect in combination with the first aspect, the processing system is further configured to perform a plurality of image blending operations associated with the composite image.

In a third aspect in combination with one or more of the first aspect through the second aspect, the processing system is further configured to adjust a quantity of the plurality of image blending operations from the first quantity to the second quantity.

In a fourth aspect in combination with one or more of the first aspect through the third aspect, the processing system is further configured to determine a plurality of candidate quantity values of the multi-frame image capture operation respectively associated with at least a subset of the plurality of image blending operations.

In a fifth aspect in combination with one or more of the first aspect through the fourth aspect, the second quantity of frames corresponds to a weighted average of the first quantity and the plurality of candidate quantity values.

In a sixth aspect in combination with one or more of the first aspect through the fifth aspect, the processing system is further configured to determine the first quantity of frames in accordance with a first ambient lighting condition associated with the camera and to determine the second quantity of frames in accordance with one or more second ambient lighting conditions associated with the camera.

In a seventh aspect in combination with one or more of the first aspect through the sixth aspect, the processing system is further configured to determine the first ambient lighting condition in accordance with one or more of a first autoexposure (AE) parameter, a first auto white balance (AWB) parameter, a first autofocus (AF) parameter, a first AE, AWB, and AF (3A) parameter, or a first sensitivity parameter.

In an eighth aspect in combination with one or more of the first aspect through the seventh aspect, the processing system is further configured to, after initiating the multi-frame image capture operation and prior to completing the multi-frame image capture operation, determine the one or more second ambient lighting conditions in accordance with one or more of a second AE parameter different than the first AE parameter, a second AWB parameter different than the first AWB parameter, a second AF parameter different than the first AF parameter, a second 3A parameter different than the first 3A parameter, or a second sensitivity parameter different than the first sensitivity parameter.

In a ninth aspect in combination with one or more of the first aspect through the eighth aspect, the one or more memories include a circular buffer.

In a tenth aspect in combination with one or more of the first aspect through the ninth aspect, the processing system is further configured to retrieve at least one previously stored image frame from the circular buffer, the at least one previously stored image frame is associated with a zero shutter lag (ZSL) mode of operation, and the composite image is generated further based on the at least one previously stored image frame.

In an eleventh aspect in combination with one or more of the first aspect through the tenth aspect, the composite image is generated further based on a live image frame prior to or without the live image frame being stored to the circular buffer.

In a twelfth aspect in combination with one or more of the first aspect through the eleventh aspect, a method includes determining a first quantity of frames for a multi-frame image capture operation, capturing one or more frames of the multi-frame image capture operation using a camera, and determining a second quantity of frames for the multi-frame image capture operation after capturing the one or more frames and prior to completing the multi-frame image capture operation. The method further includes generating a composite image in accordance with the second quantity of frames.

In a thirteenth aspect in combination with the twelfth aspect, generating the composite image includes performing a plurality of image blending operations.

In a fourteenth aspect in combination with one or more of the twelfth aspect through the thirteenth aspect, the method further includes adjusting a quantity of the plurality of image blending operations from the first quantity to the second quantity.

In a fifteenth aspect in combination with one or more of the twelfth aspect through the fourteenth aspect, the method further includes determining a plurality of candidate quantity values of the multi-frame image capture operation respectively associated with at least a subset of the plurality of image blending operations.

In a sixteenth aspect in combination with one or more of the twelfth aspect through the fifteenth aspect, the second quantity of frames corresponds to a weighted average of the first quantity and the plurality of candidate quantity values.

In a seventeenth aspect in combination with one or more of the twelfth aspect through the sixteenth aspect, the first quantity of frames is determined in accordance with a first ambient lighting condition associated with the camera, and the second quantity of frames is determined in accordance with one or more second ambient lighting conditions associated with the camera.

In an eighteenth aspect in combination with one or more of the twelfth aspect through the seventeenth aspect, the method further includes determining the first ambient lighting condition in accordance with one or more of a first autoexposure (AE) parameter, a first auto white balance (AWB) parameter, a first autofocus (AF) parameter, a first AE, AWB, and AF (3A) parameter, or a first sensitivity parameter.

In a nineteenth aspect in combination with one or more of the twelfth aspect through the eighteenth aspect, the method further includes, after initiating the multi-frame image capture operation and prior to completing the multi-frame image capture operation, determining the one or more second ambient lighting conditions in accordance with one or more of a second AE parameter different than the first AE parameter, a second AWB parameter different than the first AWB parameter, a second AF parameter different than the first AF parameter, a second 3A parameter different than the first 3A parameter, or a second sensitivity parameter different than the first sensitivity parameter.

In a twentieth aspect in combination with one or more of the twelfth aspect through the nineteenth aspect, the method further includes retrieving at least one previously stored image frame from a circular buffer. The at least one previously stored image frame is associated with a zero shutter lag (ZSL) mode of operation, and the composite image is generated further based on the at least one previously stored image frame.

In a twenty-first aspect in combination with one or more of the twelfth aspect through the twentieth aspect, the composite image is generated further based on a live image frame prior to or without the live image frame being stored to the circular buffer.

In a twenty-second aspect, a non-transitory computer-readable medium stores instructions executable by one or more processors to initiate, control, or perform operations. The operations include determining a first quantity of frames for a multi-frame image capture operation, capturing one or more frames of the multi-frame image capture operation using a camera, and determining a second quantity of frames for the multi-frame image capture operation after capturing the one or more frames and prior to completing the multi-frame image capture operation. The operations further include generating a composite image in accordance with the second quantity of frames.

In a twenty-third aspect in combination with the twenty-second aspect, the operations further include performing a plurality of image blending operations associated with the composite image.

In a twenty-fourth aspect in combination with one or more of the twenty-second aspect through the twenty-third aspect, the operations further include adjusting a quantity of the plurality of image blending operations from the first quantity to the second quantity.

In a twenty-fifth aspect in combination with one or more of the twenty-second aspect through the twenty-fourth aspect, the operations further include determining a plurality of candidate quantity values of the multi-frame image capture operation respectively associated with at least a subset of the plurality of image blending operations.

In a twenty-sixth aspect in combination with one or more of the twenty-second aspect through the twenty-fifth aspect, the second quantity of frames corresponds to a weighted average of the first quantity and the plurality of candidate quantity values.

In a twenty-seventh aspect in combination with one or more of the twenty-second aspect through the twenty-sixth aspect, the first quantity of frames is determined in accordance with a first ambient lighting condition associated with the camera, and the second quantity of frames is determined in accordance with one or more second ambient lighting conditions associated with the camera.

In a twenty-eighth aspect in combination with one or more of the twenty-second aspect through the twenty-seventh aspect, the operations further include determining the first ambient lighting condition in accordance with one or more of a first autoexposure (AE) parameter, a first auto white balance (AWB) parameter, a first autofocus (AF) parameter, a first AE, AWB, and AF (3A) parameter, or a first sensitivity parameter.

In a twenty-ninth aspect in combination with one or more of the twenty-second aspect through the twenty-eighth aspect, the operations further include retrieving at least one previously stored image frame from a circular buffer, the at least one previously stored image frame is associated with a zero shutter lag (ZSL) mode of operation, and the composite image is generated further based on the at least one previously stored image frame.

In a thirtieth aspect in combination with one or more of the twenty-second aspect through the twenty-ninth aspects, the composite image is generated further based on a live image frame prior to or without the live image frame being stored to the circular buffer.

In the figures, a single block may be described as performing a function or functions. The function or functions performed by that block may be performed in a single component or across multiple components, and/or may be performed using hardware, software, or a combination of hardware and software. To illustrate, various illustrative components, blocks, modules, circuits, and operations are described generally in terms of their functionality. Whether such functionality is implemented as hardware or software may depend upon the particular application and design of the overall system. Skilled artisans may implement the described functionality in varying ways for each particular application, but such implementation decisions should not be interpreted as a departure from the scope of the disclosure. Also, the example devices may include components other than those shown, such as a processor, memory, and the like.

Aspects of the disclosure are applicable to any electronic device including, coupled to, or otherwise processing data from one, two, or more image sensors capable of capturing image frames (or “frames”). The terms “output image frame,” “modified image frame,” and “corrected image frame” may refer to an image frame that has been processed by any of the disclosed techniques to adjust raw image data received from an image sensor. Further, aspects of the disclosed techniques may be implemented for processing image data received from image sensors of the same or different capabilities and characteristics (such as resolution, shutter speed, or sensor type). Further, aspects of the disclosed techniques may be implemented in devices for processing image data, whether or not the device includes or is coupled to image sensors. For example, the disclosed techniques may include operations performed by processing devices in a cloud computing system that retrieve image data for processing that was previously recorded by a separate device having image sensors.

Unless specifically stated otherwise as apparent from the following discussions, it is appreciated that throughout the present application, discussions using terms such as “accessing,” “receiving,” “sending,” “using,” “selecting,” “determining,” “normalizing,” “multiplying,” “averaging,” “monitoring,” “comparing,” “applying,” “updating,” “measuring,” “deriving,” “settling,” “generating,” or the like, refer to the actions and processes of a computer system, or similar electronic computing device, that manipulates and transforms data represented as physical (electronic) quantities within the computer system's registers and memories into other data similarly represented as physical quantities within the computer system's registers, memories, or other such information storage, transmission, or display devices. The use of different terms referring to actions or processes of a computer system does not necessarily indicate different operations. For example, “determining” data may refer to “generating” data. As another example, “determining” data may refer to “retrieving” data.

The terms “device” and “apparatus” are not limited to one or a specific number of physical objects (such as one smartphone, one camera controller, one processing system, and so on). As used herein, a device may be any electronic device with one or more parts that may implement at least some portions of the disclosure. While the description and examples herein use the term “device” to describe various aspects of the disclosure, the term “device” is not limited to a specific configuration, type, or number of objects. As used herein, an apparatus may include a device or a portion of the device for performing the described operations.

Certain components in a device or apparatus described as “means for accessing,” “means for receiving,” “means for sending,” “means for using,” “means for selecting,” “means for determining,” “means for normalizing,” “means for multiplying,” or other similarly-named terms referring to one or more operations on data, such as image data, may refer to processing circuitry (e.g., application specific integrated circuits (ASICs), digital signal processors (DSP), graphics processing unit (GPU), central processing unit (CPU), computer vision processor (CVP), or neural signal processor (NSP)) configured to perform the recited function through hardware, software, or a combination of hardware configured by software.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Components, the functional blocks, and the modules described herein with respect to the Figures referenced above include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, application, software applications, software packages, routines, subroutines, objects, executables, threads of execution, procedures, and/or functions, among other examples, whether referred to as software, firmware, middleware, microcode, hardware description language or otherwise. In addition, features discussed herein may be implemented via specialized processor circuitry, via executable instructions, or combinations thereof.

Although some examples may be described separately for convenience, those of skill in the art will recognize that such examples may be combined without departing from the scope of the disclosure. For example, one or more blocks (or operations) of FIG. 3 may be combined with one or more blocks (or operations) of FIGS. 1-2. As another example, one or more blocks of FIG. 4 may be combined with one or more blocks (or operations) of FIGS. 1-2. As an additional example, one or more blocks (or operations) of FIG. 3 may be combined with one or more blocks (or operations) of FIG. 4.

Those of skill in the art would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the disclosure. Skilled artisans will also readily recognize that the order or combination of components, methods, or interactions that are described herein are merely examples and that the components, methods, or interactions of the various aspects of the disclosure may be combined or performed in ways other than those illustrated and described herein.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits, and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, or, any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, which is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein but are to be accorded the widest scope consistent with this disclosure, the principles and the novel features disclosed herein.

Additionally, a person having ordinary skill in the art will readily appreciate, opposing terms such as “upper” and “lower,” or “front” and back,” or “top” and “bottom,” or “forward” and “backward” are sometimes used for ease of describing the figures, and indicate relative positions corresponding to the orientation of the figure on a properly oriented page, and may not reflect the proper orientation of any device as implemented.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown, or in sequential order, or that all illustrated operations be performed to achieve desirable results. Further, the drawings may schematically depict one or more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As used herein, including in the claims, the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof.

The term “substantially” is defined as largely, but not necessarily wholly, what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 1, 5, or 10 percent.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. An apparatus comprising:
a processing system that includes one or more memories and one or more processors coupled to the one or more memories, the processing system configured to:
determine a first quantity of frames for a multi-frame image capture operation;
initiate capture of one or more frames of the multi-frame image capture operation using a camera;
after capturing the one or more frames and prior to completing the multi-frame image capture operation, determine a second quantity of frames for the multi-frame image capture operation; and
generate a composite image in accordance with the second quantity of frames.

2. The apparatus of claim 1, wherein the processing system is further configured to perform a plurality of image blending operations associated with the composite image.

3. The apparatus of claim 2, wherein the processing system is further configured to adjust a quantity of the plurality of image blending operations from the first quantity to the second quantity.

4. The apparatus of claim 2, wherein the processing system is further configured to determine a plurality of candidate quantity values of the multi-frame image capture operation respectively associated with at least a subset of the plurality of image blending operations.

5. The apparatus of claim 4, wherein the second quantity of frames corresponds to a weighted average of the first quantity and the plurality of candidate quantity values.

6. The apparatus of claim 1, wherein the processing system is further configured to determine the first quantity of frames in accordance with a first ambient lighting condition associated with the camera and to determine the second quantity of frames in accordance with one or more second ambient lighting conditions associated with the camera.

7. The apparatus of claim 6, wherein the processing system is further configured to determine the first ambient lighting condition in accordance with one or more of a first autoexposure (AE) parameter, a first auto white balance (AWB) parameter, a first autofocus (AF) parameter, a first AE, AWB, and AF (3A) parameter, or a first sensitivity parameter.

8. The apparatus of claim 7, wherein the processing system is further configured to, after initiating the multi-frame image capture operation and prior to completing the multi-frame image capture operation, determine the one or more second ambient lighting conditions in accordance with one or more of a second AE parameter different than the first AE parameter, a second AWB parameter different than the first AWB parameter, a second AF parameter different than the first AF parameter, a second 3A parameter different than the first 3A parameter, or a second sensitivity parameter different than the first sensitivity parameter.

9. The apparatus of claim 1, wherein the one or more memories include a circular buffer.

10. The apparatus of claim 9, wherein the processing system is further configured to retrieve at least one previously stored image frame from the circular buffer, wherein the at least one previously stored image frame is associated with a zero shutter lag (ZSL) mode of operation, and wherein the composite image is generated further based on the at least one previously stored image frame.

11. The apparatus of claim 9, wherein the composite image is generated further based on a live image frame prior to or without the live image frame being stored to the circular buffer.

12. A method comprising:
determining a first quantity of frames for a multi-frame image capture operation;
capturing one or more frames of the multi-frame image capture operation using a camera;
after capturing the one or more frames and prior to completing the multi-frame image capture operation, determining a second quantity of frames for the multi-frame image capture operation; and
generating a composite image in accordance with the second quantity of frames.

13. The method of claim 12, wherein generating the composite image includes performing a plurality of image blending operations.

14. The method of claim 13, further comprising adjusting a quantity of the plurality of image blending operations from the first quantity to the second quantity.

15. The method of claim 13, further comprising determining a plurality of candidate quantity values of the multi-frame image capture operation respectively associated with at least a subset of the plurality of image blending operations.

16. The method of claim 15, wherein the second quantity of frames corresponds to a weighted average of the first quantity and the plurality of candidate quantity values.

17. The method of claim 12, wherein the first quantity of frames is determined in accordance with a first ambient lighting condition associated with the camera, and wherein the second quantity of frames is determined in accordance with one or more second ambient lighting conditions associated with the camera.

18. The method of claim 17, further comprising determining the first ambient lighting condition in accordance with one or more of a first autoexposure (AE) parameter, a first auto white balance (AWB) parameter, a first autofocus (AF) parameter, a first AE, AWB, and AF (3A) parameter, or a first sensitivity parameter.

19. The method of claim 18, further comprising, after initiating the multi-frame image capture operation and prior to completing the multi-frame image capture operation, determining the one or more second ambient lighting conditions in accordance with one or more of a second AE parameter different than the first AE parameter, a second AWB parameter different than the first AWB parameter, a second AF parameter different than the first AF parameter, a second 3A parameter different than the first 3A parameter, or a second sensitivity parameter different than the first sensitivity parameter.

20. The method of claim 12, further comprising retrieving at least one previously stored image frame from a circular buffer, wherein the at least one previously stored image frame is associated with a zero shutter lag (ZSL) mode of operation, and wherein the composite image is generated further based on the at least one previously stored image frame.

21. The method of claim 20, wherein the composite image is generated further based on a live image frame prior to or without the live image frame being stored to the circular buffer.

22. A non-transitory computer-readable medium storing instructions executable by one or more processors to initiate, control, or perform operations, the operations comprising:
determining a first quantity of frames for a multi-frame image capture operation;
capturing one or more frames of the multi-frame image capture operation using a camera;
after capturing the one or more frames and prior to completing the multi-frame image capture operation, determining a second quantity of frames for the multi-frame image capture operation; and
generating a composite image in accordance with the second quantity of frames.

23. The non-transitory computer-readable medium of claim 22, wherein the operations further include performing a plurality of image blending operations associated with the composite image.

24. The non-transitory computer-readable medium of claim 23, wherein the operations further include adjusting a quantity of the plurality of image blending operations from the first quantity to the second quantity.

25. The non-transitory computer-readable medium of claim 23, wherein the operations further include determining a plurality of candidate quantity values of the multi-frame image capture operation respectively associated with at least a subset of the plurality of image blending operations.

26. The non-transitory computer-readable medium of claim 25, wherein the second quantity of frames corresponds to a weighted average of the first quantity and the plurality of candidate quantity values.

27. The non-transitory computer-readable medium of claim 22, wherein the first quantity of frames is determined in accordance with a first ambient lighting condition associated with the camera, and wherein the second quantity of frames is determined in accordance with one or more second ambient lighting conditions associated with the camera.

28. The non-transitory computer-readable medium of claim 27, wherein the operations further include determining the first ambient lighting condition in accordance with one or more of a first autoexposure (AE) parameter, a first auto white balance (AWB) parameter, a first autofocus (AF) parameter, a first AE, AWB, and AF (3A) parameter, or a first sensitivity parameter.

29. The non-transitory computer-readable medium of claim 22, wherein the operations further include retrieving at least one previously stored image frame from a circular buffer, wherein the at least one previously stored image frame is associated with a zero shutter lag (ZSL) mode of operation, and wherein the composite image is generated further based on the at least one previously stored image frame.

30. The non-transitory computer-readable medium of claim 29, wherein the composite image is generated further based on a live image frame prior to or without the live image frame being stored to the circular buffer.
